(19) United States
(12) Patent Application Publication
(10) Pub. No.: US 2016/0279011 A1
(43) Pub. Date: Sep. 29, 2016

(54) Passive Knee Joint and Knee Extension Device

(71) Applicant: David C. Lutz, Boerne, TX (US)

(72) Inventor: David C. Lutz, Boerne, TX (US)

(21) Appl. No.: 14/936,769

(22) Filed: Nov. 10, 2015

Related U.S. Application Data
(63) Continuation-in-part of application No. 14/670,644, filed on Mar. 27, 2015.

(51) Int. Cl. A61H 1/02

(52) U.S. Cl. CPC A61H 1/024

(57) ABSTRACT

Disclosed is a passive gravity assist flexion and/or extension device, principally for regaining knee joint range of motion flexibility; having such arrangement to provide appropriate content vertically stable elevated under knee support of the posterior intersection, concerning the femur and tibia of an impaired knee joint and/or concerning the subtalar joint (ankle); whereby promoting gravity assist passive flexion and/or extension towards gradual content knee joint muscle stretching. The disclosed device arrangement, being comprised of a padded solitary horizontal support bar, capable of desired lateral rotational movement, while firmly affixed mid-span atop a vertical linear traveling wholly enclosed height adjustable threaded rod. Whereby adjustable rod thread engagement means, establishes and maintains desired horizontal support bar height position. Furthermore, the disclosed device utilizes a center base foundation arrangement providing a resolute perpendicular stable knee support means.

### RELATED APPLICATIONS

This application is a Continuation-in-Part of U.S. Ser. No. 14/670,644 filed on Mar. 27, 2015 entitled “Flexible Knee Joint Flexion Device”

### BACKGROUND OF THE INVENTION

Consequential of knee injury and/or surgery, some form of resolve is imperative towards restoring full range of motion (ROM) by gradual stretching of contracted associated muscle; frequently accomplished by having some form of elevated support placed directly under the knee joint (for knee flexion) or directly under the ankle (for knee extension); functioning as a fulcrum from which the lower leg slowly descends during flexion and/or the leg center (knee) slowly straightens (extension) while passively elongating allied muscle. Examples of such typical fulcrum(s) being a paper towel roll; having another as a firmly rolled fabric towel fashioning a cylinder; conceivably a sofa arm, or even the perimeter edge of a bed and/or examination table.

One popular physical therapy knee flexion practice is by having an individual supine positioned on a fairly flat surface, such as a table; having the non-impaired leg convex positioned at somewhat of a 45 degree angle, having the foot sole flatly placed, whereby fashioning an apex for which a second party (physical therapist) can place the palm of a hand upon; thereby achieving an under bridge for which the impaired knee posterior may rest upon; functioning as an elevated fulcrum for which the leg's lower portion may slowly descend, gradually stretching knee joint muscle.

Whereas a simplistic knee extension physical therapy practice is towards having an individual supine positioned on a fairly flat surface, such as a table; having the impaired leg's heel resting upon a reasonably elevated supporting means; whereby the leg's knee portion may slowly descend and/or straighten, gradually stretching knee joint muscle.

Towards this end, specific prior art is absent associated with knee joint gravity assist passive flexion and/or extension; whereby being such a devoted device towards resolute posterior support of a knee joint and/or an ankle at a purposeful fixed height. Conversely, one significant absent element of the previously portrayed acting fulcrum(s) is their mechanical inability to contently offer pivot support position compensating for minimal individual knee joint natural pivotal distortion movement while the lower leg and/or knee sector gradually descends. Lacking this simplistic mechanical capability within customary elevated fulcrum support solutions can be relatively uncomfortable.

### SUMMARY OF THE INVENTION

Disclosed is a passive gravity assist flexion and/or extension device, principally for regaining knee joint range of motion flexibility; having such arrangement to provide appropriate content vertically stable elevated under knee support of the posterior intersection, concerning the femur and tibia of an impaired knee joint and/or concerning the subtalar joint (ankle); whereby promoting gravity assist passive flexion and/or extension towards gradual content knee joint muscle stretching. The disclosed device arrangement, being comprised of a padded solitary horizontal support bar, capable of desired lateral rotational movement, while firmly affixed mid-span atop a vertical linear traveling wholly enclosed height adjustable threaded rod. Whereby adjustable rod thread engagement means, establishes and maintains desired horizontal support bar height position. Furthermore, the disclosed device utilizes a center base foundation arrangement providing a resolute perpendicular stable knee support means.

The above brief description sets forth rather broadly the more important features of the present invention in order that the detailed description thereof that follows may be better understood, and in order that the present contributions to the art may be better appreciated. There are, of course, additional features of the present invention that will be described hereinafter and which will form the subject matter of the claims appended hereto.

In this respect, before explaining the preferred embodiment of the present invention in detail, it is to be understood that the invention is not limited in its application to the details of the construction and to the arrangements of the components set forth in the following description or illustrated in the drawings. The present invention is capable of other embodiments and of being practiced and carried out in various ways. Also, it is to be understood, that the phraseology and terminology employed herein are for the purpose of description and should not be regarded as limiting.

As such, those skilled in the art will appreciate that the concept, upon which this disclosure is based, may readily be utilized as a basis for designing other structures, methods, and systems for carrying out several purposes of the present invention. It is important, therefore, that the claims be regarded as including such equivalent constructions insofar as they do not depart from the spirit and scope of the present invention.

It is therefore an objective of the present invention to provide a new and unique economically realized passive knee muscle stretching device, wherein the various elements of the invention can be examined towards purposeful knee joint flexibility, range of motion, and strengthening.

An additional objective of the present invention is providing such an arrangement to appropriately and contently support the posterior intersection relationship of the femur and tibia of an impaired knee joint; whereby promoting gravity assist passive flexion specific towards gradual knee joint muscle stretching.

Whereas, an additional objective of the present invention is providing such an arrangement to appropriately and contently support the posterior intersection relationship concerning the subtalar joint (ankle); whereby promoting gravity assist passive extension specific towards gradual knee joint muscle stretching.

It is also an objective of the present invention to provide a device comprised of a somewhat supple rubber padded horizontal knee posterior support bar; whereby the replaceable soft rubber pad, being lengthwise split to a mid-span aperture; being realized from such material as nitrile, neoprene, polysulfide, silicone, urethane, but not limited to; whereas said horizontal knee posterior support bar being of determined length, having rounded ends; incorporating a vertical coaxial bored hole and counter-bore located mid span; whereby having a small horizontal aperture located 90 degrees opposed of said vertical bored hole; whereby said solid support bar, round in form; being realized from such material as ferrous or nonferrous metal, plastic, wood, carbon fiber, composite, fiberglass, but not limited to.

It is also an objective of the present invention to provide a device comprised of a height adjustment continual male threaded rod, of agreed length; whereby having one end tolerance machined a determined length; wherein having a small horizontal aperture located mid-span of said machined length; whereby having opposed end considered conical; being realized from such material as ferrous or nonferrous metal, plastic, wood, carbon fiber, polycarbonate, composite, fiberglass, but not limited to.

It is also an objective of the present invention to provide a device comprised of a height adjustment male threaded rod protective sheathing, being of tubular form; whereby said determined length sheathing, having one end incorporate a supplemental bushing style insert possessing female threads alike that of said height adjustment rod; whereby both sheathing and said insert being realized from such material as ferrous or nonferrous metal, plastic, wood, carbon fiber, polycarbonate, composite, fiberglass, but not limited to.

It is also an objective of the present invention to provide a device comprised of a height adjustment male threaded rod support housing, being of tubular form; similar in length to that of said male threaded rod; whereby said determined length tube having opposed square blunt ends; whereby one end incorporates a supplemental bushing style insert possessing female threads equivalent to that of said height adjustment rod; whereby opposing tube end incorporates a similar supplemental insert possessing decreased diameter female threads, being equivalent to that of an adequate mechanical attachment means towards securing tubular housing and base hub (subsequently described); whereby said tube housing and said inserts being realized from such material as ferrous or nonferrous metal, plastic, wood, carbon fiber, polycarbonate, composite, fiberglass, but not limited to.

It is also an objective of the present invention to provide a device comprised of a single center base hub; circular in form; being machined, molded or cast formed; having a center located vertical bore, of determined depth and diameter; whereby said bore diameter being slightly greater than that of said tube housing outside diameter; having said bore considered downward traveling; wherein incorporating a reduced diameter center located aperture and associated counter-bore; moreover, said hub incorporates numerous geometrically equally spaced horizontal bores, of determined depth and diameter, whereby being located on hub perimeter centerline, when considering said hub horizontal parallel planes, thereof; having said hub realized from such material as ferrous or nonferrous metal, plastic, wood, carbon fiber, polycarbonate, thermo setting plastic(s), composite, fiberglass, but not limited to.

It is also an objective of the present invention to provide a device comprised of numerous individual, regarded as, base support horizontal appendages; being of determined diameter and length; being either solid or tube form; wherein having square blunt ends; being realized from such material as ferrous or nonferrous metal, plastic, wood, carbon fiber, polycarbonate, composite, fiberglass, but not limited to.

It is also an objective of the present invention to provide a device comprised of said base support horizontal appendages having commercially available end caps affixed; whereby said end caps being of mold formed rubber, but not limited to.

It is also an objective of the present invention whereby said single padded horizontal knee posterior support bar is mechanically affixed to said male threaded rod, having threaded rod tolerance machined end inserted a predetermined depth in to cooperating support bar tolerance machined bore. Further, having considered permanent attachment accomplished by means of a single pin or commercially available roll pin, but not limited to, inserted through aligned cooperating apertures of both support bar and male threaded rod machined end; whereby having support bar and threaded rod considered perpendicular. The male threaded rod may be coated with PTFE.

It is also an objective of the present invention whereby having said female threaded bushing style insert be press-fit and/or chemical bond retained in to one end of said height adjustment male threaded rod protective tubular formed sheathing square blunt end aperture; whereby realization of cooperating male threaded rod free end being inserted in to said female threaded bushing affords a secure attachment means of said sheathing.

It is also an objective of the present invention whereby having said female threaded bushing style insert be press-fit and/or chemical bond retained in to one of the said vertical support tube housing accommodating square blunt end apertures; whereby realizing thread insertion of cooperating male threaded rod free end in to said female threaded bushing; thereby affording determined rotation ascending and descending vertical linear travel.

It is also an objective of the present invention whereby the mechanically affixed padded horizontal knee posterior support bar, incorporating affixed sheathing, will horizontally rotate in concert with said adjustable male threaded rod's clockwise or counter-clockwise rotation.

It is also an objective of the present invention whereby the mechanically affixed padded horizontal knee posterior support bar and affixed sheathing be somewhat separated by way of a commercially available pliable molded rubber circular ring, of round or square design. Whereby said rubber ring, being considered as a movement absorption means, affording sheathing liberty of self-centering, when considering sheathing inside interface surface contact with that of support housing outside surface, while rotating in concert with height adjustment male threaded rod's clockwise or counter-clockwise rotation.

It is also an objective of the present invention whereby the opposed end of said vertical support tube housing, having a female threaded bushing style insert installed, be perpendicularly introduced in to the accommodating center base hub bore, a predetermined depth; whereby accomplishing said housing end entrapment by capitalizing on a slight tolerance slip-fit considered between a slightly reduced outside diameter housing tube end and that of a slightly enlarged accommodating base hub receiving harbor bore; having this slip-fit union semi-permanently affixed by means of mechanical attachment; consequential mechanical means removal affords for separation of the completed structure thereof; whereby accommodating for packaging, transportation, and storage purposes.

It is also an objective of the present invention wherein said center base hub, having numerous geometrically equally spaced nesting harbor bores located on the circumference peripheral face; wherein said bores being of determined depth and diameter; entertain the press-fit insertion of cooperating appendage blunt ends. Whereby having said press-fit amalgamation permanently affixed by means of mechanical, fusion or chemical bonding, but not limited to; thereby said appendages being considered horizontal relative of said base hub opposed horizontal parallel planes, respectfully.

It is also an objective of the present invention wherein said appendages having accommodating rubber end caps pressed on exposed appendage blunt ends; thereby achieving a positive placement non-slip configuration.

It is another object of the present invention to provide a knee joint gravity assist passive flexion device, which may be easily and efficiently manufactured and marketed.

It is a further objective of the present invention of knee joint gravity assist passive flexion device, which is of durable and reliable construction.

It is therefore an objective of the present invention to provide a unique economically realized passive knee muscle stretching device; wherein the various elements of the apparatus can be examined.

An even further object of the present invention is to provide a knee joint gravity assist passive flexion assembly, which is receptive of a low cost of manufacture with regard to both material(s) and labor, and which accordingly is then susceptible of low price of sale to the consuming community, thereby making such a knee joint gravity assist passive flexion device readily available to the buying public.

These together with still other objects of the present invention, along with the various features of novelty, which characterize the present invention, are pointed out with particularity in the claims annexed too and forming a part of this disclosure. For a better understanding of the present invention, its operating advantages and the specific objects attained by its uses, reference should be made to the accompanying drawings and descriptive matter in which there are illustrated embodiments of the present invention.

### BRIEF DESCRIPTION OF THE DRAWINGS

The invention will be better understood and the above objects as well as objects other than those set forth above will become more apparent after a conscientious study of the following detail description thereof. Such description makes reference to the annexed drawings wherein:

FIG. 1 being a 3 dimensional illustration of the revealed present invention preferred embodiment.

FIG. 2 being a 3 dimensional illustration having partial cross-sectional views revealing specific present invention preferred embodiment elements.

FIG. 3 being an exploded 3 dimensional illustration having partial cross-sectional views revealing specific present invention preferred embodiment elements.

FIG. 4 being an artistic side view illustration of the revealed present invention preferred embodiment, in demonstration.

FIG. 5 being an artistic vertical downward view representative illustration of the revealed present invention horizontal knee posterior support bar preferred embodiment, in demonstration.

FIG. 6 being an artistic vertical downward view illustrative of the revealed present invention horizontal knee posterior support bar preferred embodiment, demonstrating gyratory capability.

FIG. 7 being a photograph of the revealed present invention preferred embodiment reflecting three alternative support bar adjusted height levels.

### DESCRIPTION OF THE PREFERRED EMBODIMENT

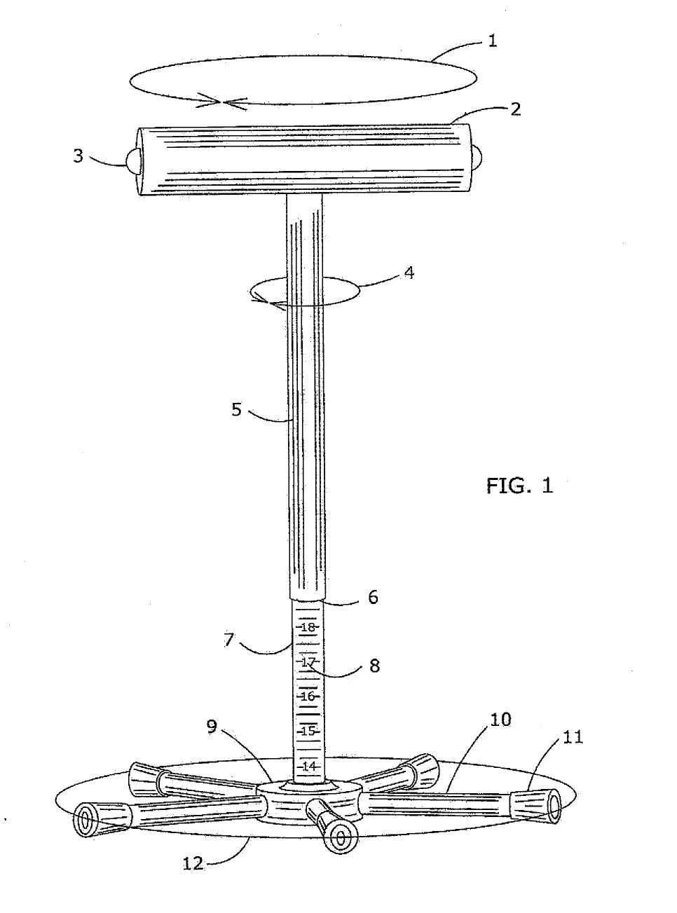

With reference now to the drawings, a novel and unique knee joint gravity assist passive flexion and/or extension device embodying the principles and concepts of the present invention will be fully disclosed. Referencing now specifically FIG. 1 as being a 3 dimensional illustration of the present invention; whereby having a supple cylindrical shaped foam rubber pad 2 encompassing a somewhat lengthier horizontal knee posterior support bar 3; having height adjustment rod sheathing 5 conclusion 6 function as an instant reference, consideration given towards height level ruled measurement sectors 8 embossed outwardly on vertical support housing 7; whereby realizing structure conclusion by having said support housing 7 and cooperating base support hub 9 resolutely affixed. Continuing having said support hub 9 utilizing numerous appendages 10, employing rubber molded end cap(s) 11, towards achievement of a stable horizontal foundation. Further, having imaginary peripheral circumference 12 augmented from that of horizontal support bar 3, exhibited by imaginary circular plane 1; therefore considered contributory towards realization of an uncompromising vertically stable knee support device. It will be apparent to those familiar in the art that said foam rubber pad 2 encompassed horizontal knee posterior support bar 3 and said rod sheathing 5 rotate in circular accord throughout desired physical height adjustment clockwise and/or counterclockwise rotation.

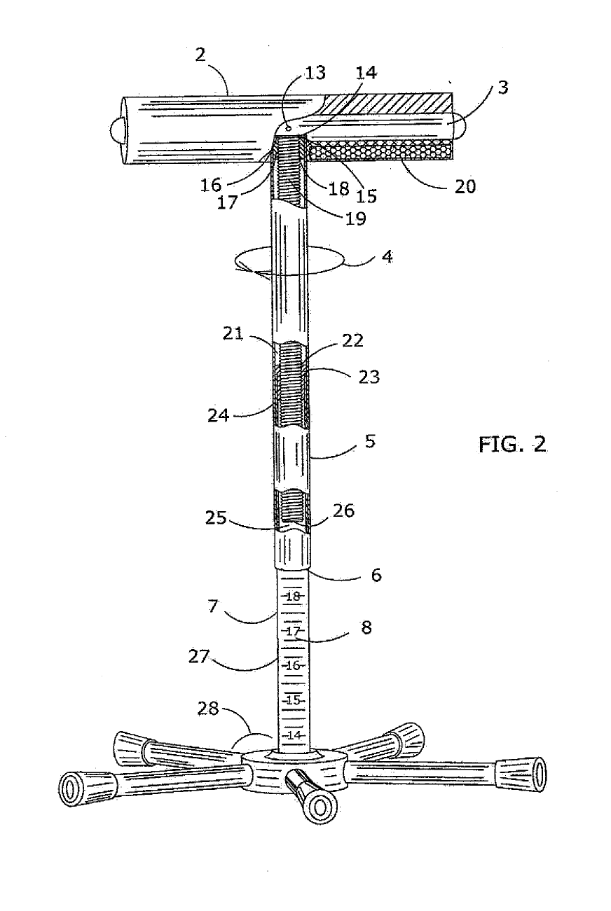

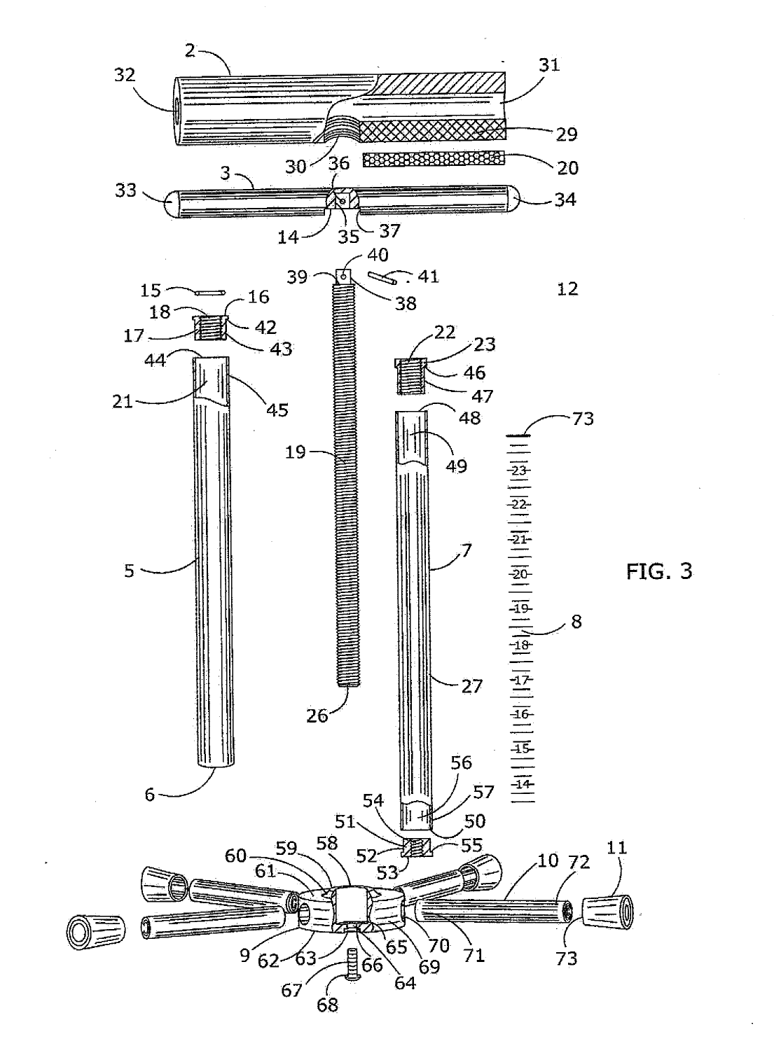

Referencing now FIG. 2 being a 3 dimensional illustration having partial cross-sectional views revealing specific present invention preferred embodiment elements; whereby having a replaceable supple rubber pad 2, FIG. 1, reasonably detained upon horizontal knee posterior support bar 3, FIG. 1, but not necessarily central, by some reliable means such as publicly recognized Velcro 20, or some other such commercially available attachment method. Continuing along with said knee support bar 3 aperture 13 utilized towards affording perpendicular fixed attachment of commercially acknowledged “all thread”; whereby being employed as height adjustment rod 19; having said adjustment rod 19 protectively enclosed within tubular sheathing 5, FIG. 1; whereby having full enclosure preserved by having one end of said sheathing 5 incorporate a female threaded bushing insert 17; having female threads 18 accommodate said male threaded height adjustment rod 19; further utilizing a dual purpose pliable material isolation spacer 15, such as a commercially obtainable rubber ring, being of round and/or square design; purposefully located at the immediate juncture of said knee support bar 3 and that of said height adjustment rod 19; where upon said male threaded rod 19 conical end 26 commence engagement with cooperating female threaded aperture 18 of said bushing insert 17; whereby having full rotational travel conclude upon contact with said rubber ring 15; thereby having said sheathing 5 shielding the full length of said height adjustment rod 19. It will be apparent to those familiar in the art that the dual purpose pliable isolation spacer ring 15 performs such as a friction lock when moderately sandwiched amid said sheathing 5 bushing insert 17 face 16 and that of said knee support bar 3 landing 14, thereof. Further, having said isolation ring 15 customary pliability affording orbital liberty of said sheathing 5 internal circumferential bore surface 21 roundabout that of external circumferential surface 27 of support tube housing 7; being exemplified by height regulating continual interfacing 24, thereof. It should be appreciated that substantial vertical solidarity spawns throughout the determined collaborative interfacing interaction 24 concerning support tube 7 exterior face 27 and that of sheathing 5 bore 21, respectfully. Whereby having sheathing 5 vertical linear telescoping transpires during said height adjustment rod 19 itinerant movement through threaded aperture 22 of bushing insert 23, thereof. Continuing on with said height adjustment rod 19; whereby providing accurate diminutive linear vertical unrestricted travel within vertical support tube housing 7 bore 25, thereof; whereby having said height adjustment rod 19 conical end 26 male thread engagement with cooperating female threaded bushing 23 at thread engagement 22; having said female threaded bushing insert 23 affixed atop squared blunt tube end 48, FIG. 3, of said vertical support housing 7. It will be apparent to those skilled in the art that it is here where the novelty and uniqueness of the present invention transpires; whereby having horizontal support bar 3, FIG. 1, resolutely attached to said height adjustment rod 19 utilizing said aperture 13; thereby having all height adjustment rod 19 physical clockwise or counterclockwise rotation, represented by imaginary circular plane 4, FIG. 1; being indistinguishable from horizontal support bar 3 physical clockwise or counterclockwise horizontal rotation, represented by imaginary circular plane 1, FIG. 1. Further, whereby having said knee support bar 3 desired height recognized; while still affording purposeful diminutive horizontal clockwise or counterclockwise rotational positioning movement liberty of said knee support bar 3. Whereupon having an impaired lower leg outwardly extended over and resting upon padded 2, FIG. 1, horizontal knee posterior support bar 3, FIG. 1, whereas said support bar 3 now be considered a fulcrum, thereby fully supporting cantilevered lower leg, commencing at the posterior intersection relationship of the femur and tibia. Further, conclusively divulging the present invention novelty and uniqueness by exposing the liberated rotating horizontal knee posterior support bar 3, whereby said support bar 3 having such liberty towards anatomically self positioning; thereby accommodating for varying individual knee linearity geometry, while the extended lower leg gradually descends, naturally, while being gravity assisted; whereby providing proper horizontal and lateral knee support bar 3 positioning proportional to individual knee geometry during gravity assist passive flexion. Moreover, a convenience vertical height scale 8, FIG. 1, embossed on support tube housing 7, FIG. 1, face 27 affords a prompt tangible reference of knee support bar 3 relative height location designated by sheathing 5, FIG. 1, conclusion 6, FIG. 1. Whereby concluding having said vertical support tube housing 7, FIG. 1, resolutely affixed within horizontal base support arrangement represented by 28.

Referencing now FIG. 3 being an exploded 3 dimensional illustration having partial cross-sectional views encompassing essential elements of the present invention; whereby having a replaceable supple foam rubber pad 2, FIGS. 1 & 2, deemed tubular in shape; wherein considering the bottom section be longitudinally split 29 to mid-length; whereupon said split 29 encounters a mid-span, considered bottom, center located vertical aperture 30; whereby said vertical aperture 30 having a diameter equaling that of sheathing 5, FIGS. 1 & 2, outer diameter 45; further considering exposed split surface 29 as a target attachment face for Velcro strip 20, FIG. 2. It will be apparent to those familiar in the art that a corrosponding opposed split surface; being parallel to that of said split surface 29; whereby having apposed split exposed surface accessible as a target attachment face for bonding of a collaborating Velcro strip, alike said Velcro strip 20. Continuing on with horizontal knee posterior support bar 3, FIGS. 1 & 2, having sphere shaped ends 33 & 34; wherein said support bar 3, incorporates a determined depth vertical coaxial bore 35 and collaborating counter-bore 37; being located mid-span of longitudinal centerline of said knee support bar 3, whereby being considered knee support bar 3 bottom, respectfully. Moreover, said support bar 3 incorporates a mid-span purposeful horizontal aperture 36, being located on longitudinal centerline, 90 degrees opposed of said vertical coaxial bore 35. Whereby having continual male threaded height adjustment rod 19, FIG. 2, incorporating a purposefully machined end 38; being of a determined length, terminating at what is considered landing 39; whereby having said threaded rod 19 machined end 38 slip-fit nested in to said horizontal support bar 3 cooperating vertical bore 35; whereupon having said rod 19, landing 39 interface with said support bar 3, counter-bore 35 landing 14, FIG. 2; wherein having said support bar 3, aperture 13, FIG. 2, and opposed cooperating aperture 36 aligned with collaborating aperture 40 of said threaded adjustment rod 19, machined end 38; whereby realizing insertion of roll-pin 41, commencing with said aperture 13 entry; progressing through aligned cooperating said aperture 40 of said adjustment rod 19 machined end 38; concluding having said roll-pin 41 insertion travel final nesting in said support bar 3, cooperating aperture 35; henceforth considering said support bar 3 and said threaded adjustment rod 19 be perpendicular, respectfully. Continuing now with dual purpose pliable isolation spacer ring 15, FIG. 2, being slid and/or rolled upon said adjustment rod 19, FIG. 2; whereby having said ring 15 travel commence at said adjustment rod 19 conical end 26, FIG. 2; having said spacer ring 15 location travel continuing towards concluding interface with horizontal support rod 3, FIG. 2, counter-bore 37 landing 14, FIG. 2. Now having bushing insert 17, FIG. 2, introduced in to sheathing tube 5, FIGS. 1 & 2, bore 21, FIG. 2; whereby having introduction conclude at the interface of said bushing insert 17 landing 42 and that of said sheathing tube 5 square blunt end 44; whereby having absolute circumferential interfacing between that of said sheathing tube 5 bore 21, FIG. 2, and that of said bushing insert 17 peripheral face 43; having said bushing insert 17 feature a female threaded aperture 18, FIG. 2; whereby said female threaded aperture 18 cooperates with said male threaded adjustment rod 19. It will be apparent to those familiar in the art whereby having said bushing insert 17 threaded aperture 18 commence cooperating thread engagement with conical end 26, FIG. 2, of threaded height adjustment rod 19, FIG. 2; whereby maintaining continual thread engagement clockwise rotation; henceforth realizing a somewhat sandwiching of said pliable ring 15 transpires amid bushing insert 17 face 16, FIG. 2, and that of horizontal support bar 3 counter-bore 37 landing 14, FIG. 2; whereby having this present invention preferred embodiment element combination considered somewhat fixed. It should be recognized that the installation of supple foam rubber pad 2, FIGS. 1 & 2, is accomplished by inserting split end 29 accommodating opening 31 over horizontal knee support bar 3, FIGS. 1 & 2, sphere end 33; continue sliding said foam rubber pad 2 over said support bar 3 until tube sheathing 5, FIGS. 1 & 2, exterior circumference surface 45 engages said foam rubber pad 2 counter-bore 30; whereby having said horizontal support bar 3 enfolded, less sphere shaped ends 33 & 34 protruding somewhat equally from said rubber pad 2 end openings 32 & 31, respectfully. Continuing along with vertical support tube house 7, FIGS. 1 & 2; whereby having opposing square blunt ends 48 and 50, respectfully; having bushing insert 23, FIG. 2, nested in cooperating blunt end 48 bore 49; having said bushing insert 23 landing 46 interface with said support tube housing 7 blunt end 48; realizing absolute circumferential interface between that of said tube support housing 7 bore 48, and that of said bushing insert 23 peripheral face 47; thereby having said bushing insert 23 feature a female threaded aperture 22, FIG. 2; whereby said threaded aperture 22 collaborates with male threaded adjustment rod 19, FIG. 2. It will be apparent to those familiar in the art that it is this purposeful threading cooperation that controls, regulates, and maintains the desired height level of horizontal support bar 3, FIGS. 1 & 2. Continuing along having bushing insert 51 nested in cooperating blunt end 50 bore 56; having said bushing insert 51 landing 55 interface with said support tube housing 7 blunt end 50; realizing absolute circumferential interface between that of said tube support housing 7 bore 56, and that of said bushing insert 51 peripheral face 52; thereby having said bushing insert 51 feature a female threaded aperture 54. Continuing on with center base hub 9, FIG. 1, being of a determined diameter and thickness; whereby said base hub 9 exhibits a raised segment 60, protrudes vertically upwards from horizontal surface plane 61; whereby said elevated segment 60 having a plateau 59; being parallel with said horizontal surface 61, respectfully. Continuing with said plateau 59 having a center located determined depth and diameter nesting harbor bore 58; whereby accommodating towards slip-fit insertion of vertical support housing 7, FIGS. 1 & 2, end 57; whereby having said support housing 7 bushing insert 51 face 53 interface with floor 65 of said nesting harbor bore 58; whereby accomplishing secure vertical attachment of said support tube 7 employing mechanical means 67; whereby having said mechanical means 67 pass through accommodating aperture 64; being center located in base hub 9 nesting bore 58 floor 65; whereby having cooperating thread engagement with accommodating female threaded aperture 54 of said vertical tube housing 7 bushing insert 51; whereby having secure attachment considered accomplished upon the interface of attachment means 67 landing 68 and that of center base hub 9 horizontal plane 62 center located sallow counter-bore 63 landing 66. Continuing now with center base hub 9; wherein having numerous identical equivalent length appendages 10, FIG. 1, extending horizontally outward from said center base hub 9 peripheral circumferential face 69; whereby having said appendage(s) 10 end(s) 71 press-fit inserted a determined depth in to accommodating geometrically equally spaced nesting harbor bore(s) 70 whereby said bores 70 being located on circumferential centerline of center base hub 9 circumferential face 69 between opposing parallel face lands 61 and 62, respectfully. Continuing with individual horizontal appendage(s) 10 being considered perpendicular relative to said vertical support housing 7; whereby said appendage(s) 10 opposing end(s) 72 having commercially available non-slip rubber cap(s) 11, FIG. 1, snug slip-on fit attached in to rubber cap(s) 11 accommodating bore(s) 73; Concluding with height level ruled measurement sectors 8; whereby feasibly having said measurement sectors 8 be such as a sticker, decal, transferable label or etch embossed outwardly on vertical support housing 7; whereas said ruled measurement sectors 8 having a top stripe 73; whereas top stripe 73 is somewhat wider and identified in the color red; whereby having red top stripe 73 considered a maximum useable height level warning.

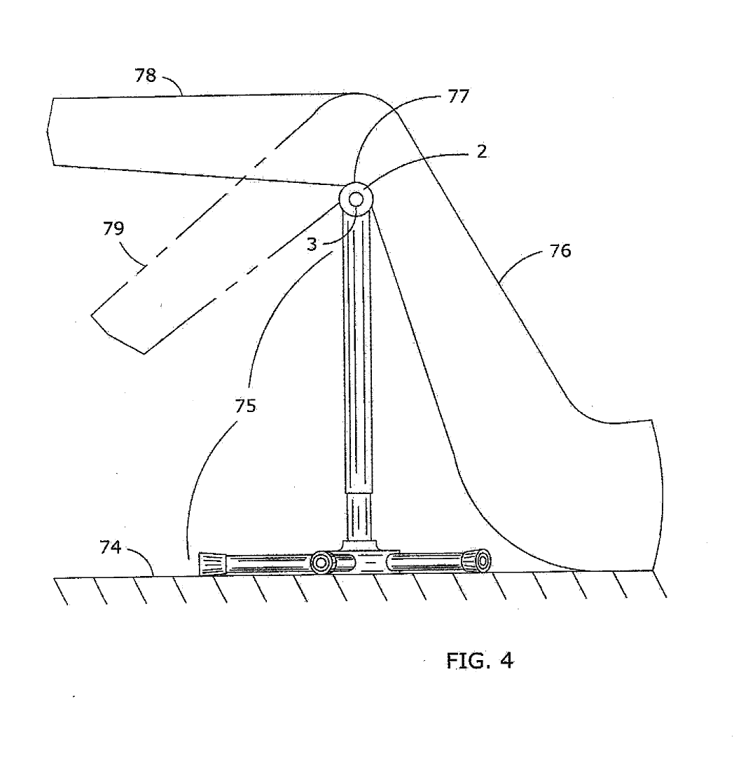

Moving now to FIG. 4 being an artistic side view illustration of the revealed present invention preferred embodiment in demonstration. Whereby having the present invention embodiment 75 placed preferably on a stabile level surface 74; whereby having simulated upper leg 76 at a comfortable forward vertical angle; having the knee joint posterior 77 confidently positioned atop foam rubber pad 2, FIGS. 1, 2 & 3, encompassing horizontal knee posterior support bar 3, FIGS. 1, 2, & 3; whereby simulated lower leg 78 being considered in cantilever; whereas having simulated lower leg 79 exemplifying descending gravity assist passive flexion. Further, it will be apparent to those skilled in the art that the revealed present invention preferred embodiment would be fully functional whereby having the subject in an alternative sitting position.

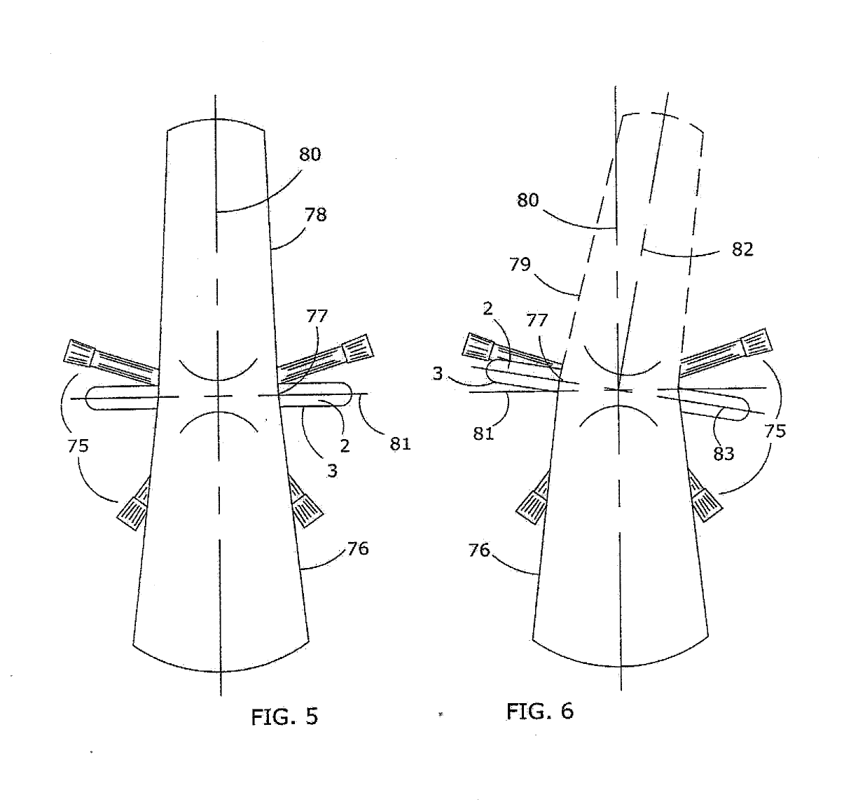

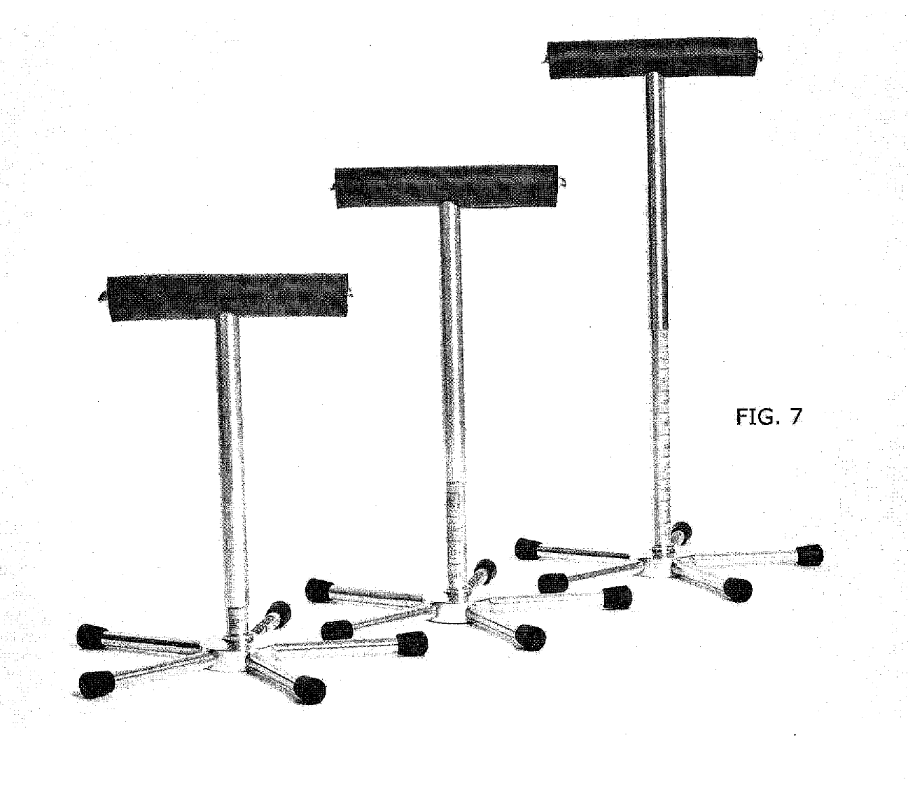

Continuing now with FIG. 5 being an artistic vertical downward view representative illustration of the revealed present invention horizontal knee posterior support bar preferred embodiment, in simulated demonstration. Whereby having the present invention embodiment 75, FIG. 4, so center positioned directly under knee joint posterior 77, FIG. 4, whereupon resting atop foam rubber pad 2, FIGS. 1, 2, 3 & 4; whereby encompassing horizontal knee posterior support bar 3, FIGS. 1, 2, 3 & 4; having an imaginary longitudinal centerline 80 of simulated upper leg 76, FIG. 4, and simulated lower leg 78, FIG. 4, indicated. Now considering said lower leg 76 being in cantilever; having an imaginary lateral centerline 81 of said foam rubber pad 2 enclosed support bar 3 being indicated; whereby said centerlines 80 and 81 being considered perpendicular.

Concluding with FIG. 6 being an artistic vertical downward view illustration of the revealed present invention horizontal knee posterior support bar preferred embodiment demonstrating gyratory capability. Whereby having the present invention embodiment 75, FIGS. 4 & 5, so center positioned directly under knee joint posterior 77, FIGS. 4 & 5, whereupon having said knee posterior 77 resting atop horizontal knee posterior support bar 3, FIGS. 1, 2, 3, 4 & 5 foam rubber pad 2, FIGS. 1, 2, 3, 4 & 5; wherein having an imaginary commencement longitudinal centerline 80, FIG. 5, of simulated upper leg 76, FIGS. 4 & 5, indicated. Now consider simulated lower leg 79, FIG. 4, gradually descending; whereby generating a second imaginary longitudinal centerline 82, commencing from knee center indicated; whereby having said horizontal support bar 3 imaginary lateral centerline 83 and that of said longitudinal centerline 82 considered perpendicular; further considering said support bar 3, whereby having liberty towards anatomically self-positioning; thereby accommodating for varying individual knee linearity geometry, while said simulated lower leg 79 gradually descends, naturally, while being gravity assisted; whereby fully disclosing the unique gyratory self-positioning capability of said horizontal support bar 3, so exhibited considering said lateral centerline 81, FIG. 5, to realized longitudinal centerline 82 not being considered perpendicular. It will be apparent to those of ordinary skill in the art that the illustrative representation of said support bar 3 lateral gyratory self-positioning being capable of contrasting rotation.

With respect to the above description, it should realized that the optimum dimensional relationships for the parts of the invention, to include variations in size, materials, shape, form, function and manner of operation, assembly and use, are deemed readily apparent and obvious to those skilled in the art, and therefore, all relationships equivalent to those illustrated in the drawings and described in the specification are intended to be encompassed only by the scope of appended claims.

While the present invention has been shown in the drawings and fully described above with particularity and detail in connection with what is presently deemed to be the most practical and preferred embodiments of the present invention, it will be apparent to those of ordinary skill in the art that many modifications therefore may be made without departing from the principles and concepts set forth herein. Hence, the novel scope of the present invention should be determined only by the broadest interpretation of the appended claims so as to encompass all such modifications and equivalents.

What is claimed as being new and desired to be protected by Letters Patent of the United States is as follows:

1. A gravity assist passive knee muscle stretching device,

2. A passive knee muscle stretching device, according to claim 1, whereby having specific intent towards gravity assist passive knee joint flexion and for that of passive knee joint extension, deliberate of regaining knee flexibility range of motion.

3. A passive knee muscle stretching device, according to claim 2, whereby providing an arrangement appropriate for content sustained elevated support of the posterior intersection relationship of the femur and tibia of a knee joint or a subtalar (ankle)

4. A passive knee muscle stretching device, according to claim 3, whereby prompting resolute gravity assist passive knee flexion or knee extension specific towards tolerable gradual stretching of allied knee joint muscle(s) from either a supine position or sitting position.

5. A passive knee muscle stretching device comprising of:
A supple foam rubber padded knee posterior horizontal support bar; having said support bar mechanically adapted atop a tubular enclosed vertical linearly traveling male threaded rod, whereby having said male threaded rod interface with a cooperating similarly female threaded element, having said female threaded element affixed to the accommodating bore of a vertical support housing; whereby having opposed end of said support housing mechanically retained in a single support base foundation arrangement, comprised of numerous strategically placed stability generating rubber end capped appendages extending horizontally from said support base.

6. A passive knee muscle stretching device, according to claim 5, whereby knee posterior horizontal support bar having liberty to revolve clockwise or counterclockwise in unison with sheathed vertically traveling male threaded height positioning rod rotation.

7. A passive knee muscle stretching device, according to claim 6, whereby knee posterior horizontal support bar having clockwise or counterclockwise rotational liberty, whereby affixed atop a sheathed linearly traveling male threaded rod, affords natural longitudinal positioning relative to individual knee anatomic geometry during gravity assist passive flexion (gradual knee joint muscle stretching).

8. A passive knee muscle stretching device, according to claim 7, whereby rotating knee posterior horizontal support bar being affixed to a sheathed vertical linear traveling male thread adjustable rod having liberty of desired adjustability towards ascending or descending linear travel.

9. A passive knee muscle stretching device, according to claim 8, whereby knee posterior horizontal support bar being attached to a sheathed linearly adjustable male threaded rod having liberty of height adjustability ascending or descending linear travel is maintained by means of accommodating female thread interfacing mechanism means.

10. A passive knee muscle stretching device, according to claim 9, whereby knee posterior horizontal support bar being affixed atop sheathed linearly traveling male threaded adjustable rod; having liberty of adjustability towards ascending or descending linear travel does not require the addition of preferred height position securable means, nor any type of position locking mechanism towards affording knee posterior horizontal support bar height stability and position maintainability.

11. A passive knee muscle stretching device, according to claim 10, whereby knee posterior horizontal support bar being affixed atop sheathed linearly traveling male threaded adjustable rod; having liberty of adjustability towards ascending or descending linear travel; whereby having a telescoping interface contact, between said sheathing inside diameter surface and that of the exterior surface of support tube housing; whereby promotes additional vertical rigidity; thereby affording knee posterior horizontal support bar height stability and position maintainability.

12. A passive knee muscle stretching device, according to claim 11, whereby having a single vertical architectural support structure framework arrangement.

13. A passive knee muscle stretching device, according to claim 12, whereby having a single vertical architectural support structure framework arrangement, being perpendicular with cooperating horizontal base support configuration

14. A passive knee muscle stretching device, according to claim 13, whereby having a single vertical architectural support structure framework arrangement, being perpendicular with cooperating horizontal base support structure configuration offering a sturdy stable knee muscle rehabilitation height adjustable elevated support device.
